(19) United States
(12) Patent Application Publication
(10) Pub. No.: US 2016/0227080 A1
(43) Pub. Date: Aug. 4, 2016

(54) APPARATUS FOR DIFFERENT SIZED MOBILE DEVICES THAT PERFORM IMAGE CAPTURE

(71) Applicant: iOgrapher, LLC, San Gabriel, CA (US)

(72) Inventors: David Basulto, San Gabriel, CA (US); Jason Ivey, Irvine, CA (US)

(21) Appl. No.: 15/087,297

(22) Filed: Mar. 31, 2016

Related U.S. Application Data
(63) Continuation-in-part of application No. 13/895,349, filed on May 15, 2013.
(60) Provisional application No. 61/768,751, filed on Feb. 25, 2013.

(51) Int. Cl. H04N 5/225; H04N 5/247

(52) U.S. Cl. CPC H04N 5/2252; H04N 5/2253; H04N 5/247

(57) ABSTRACT

An apparatus is provided. The apparatus has a first member, a second member, and a third member that couples the first member and the second member such that the second member is parallel to the first member. The third member is perpendicular to the first member and the second member. Further, the third member is in between the first member and the second member. The apparatus also has a receptacle connection device positioned on the third member that connects a receptacle to the apparatus. The receptacle is configured to receive an image capture computing device without an intervening member between an external perimeter of the image capture computing device and an external perimeter of the receptacle. The receptacle is configured to have an aperture positioned on a side of the third member between the first member and the second member.

### RELATED APPLICATIONS

This patent application is a Continuation-In-Part application of U.S. patent application Ser. No. 13/895,349, filed on May 15, 2013, entitled RECEPTACLE FOR AN IMAGE CAPTURE COMPUTING DEVICE, which claims priority to U.S. Provisional Patent Application Ser. No. 61/768,751, filed on Feb. 25, 2013, entitled A PLASTIC CASE FOR THE IPAD MINI AND IPAD. IT HAS HANDLES ON THE SIDES, 3 ACCESSORY SHOE AREAS, A TRIPOD MOUNT, AND THE ABILITY TO SCREW ON 37 MM LENSES., which are hereby incorporated by reference in their entireties.

### BACKGROUND

1. Field

This disclosure generally relates to the field of image capture. More particularly, the disclosure relates to a configuration that receives different sized mobile computing devices that performs image capture.

2. General Background

Standard cameras typically allow for utilization of a tripod. For example, a photographer can place a standard camera on a tripod so that movement of the camera during image capture is minimized. The tripod allows a photographer using a standard camera to take pictures without using both hands to stabilize the camera.

Current mobile computing devices, e.g., tablet devices, smartphones, etc., provide image capture capabilities, e.g., still or motion, that are comparable with standard image capture devices such as standard cameras. Yet the picture quality from such mobile computing devices is often of a lesser quality than that of standard cameras as standard cameras provide users with firmer stabilization abilities than a mobile computing device. Users often have difficulty keeping the mobile computing device stable during image capture. The mobile computing device often wobbles during the image capture, which then results in pictures or videos that are often of a less than ideal quality.

### SUMMARY

In one aspect of the disclosure, an apparatus is provided. The apparatus has a first member, a second member, and a third member that couples the first member and the second member such that the second member is parallel to the first member. The third member is perpendicular to the first member and the second member. Further, the third member is in between the first member and the second member. The apparatus also has a receptacle connection device positioned on the third member that connects a receptacle to the apparatus. The receptacle is configured to receive an image capture computing device without an intervening member between an external perimeter of the image capture computing device and an external perimeter of the receptacle. The receptacle is configured to have an aperture positioned on a side of the third member between the first member and the second member.

In another aspect of the disclosure, an apparatus is provided. The apparatus has a first member, a second member, and a third member that couples the first member and the second member such that the second member is parallel to the first member. The third member is perpendicular to the first member and the second member. Further, the third member is in between the first member and the second member. The apparatus also has a receptacle connection device positioned on the third member that is capable of connecting a first receptacle or a second receptacle to the apparatus. The first receptacle is configured to receive a first image capture computing device without an intervening member between an external perimeter of the first image capture computing device and an external perimeter of the first receptacle. Further, the first receptacle is configured to have an aperture positioned on a side of the third member between the first member and the second member. In addition, the second receptacle is configured to receive a second image capture computing device without an intervening member between an external perimeter of the second image capture computing device and an external perimeter of the second receptacle. The second receptacle is configured to have an aperture positioned on a side of the third member between the first member and the second member. Further, the first receptacle has a first set of dimensions. In addition, the second receptacle has a second set of dimensions. The first set of dimensions is distinct from the second set of dimensions.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a front view of an image capture computing device receptacle.

FIG. 2 illustrates a back view of the image capture computing device receptacle.

FIG. 3 illustrates a side view of the receiving means.

FIG. 4 illustrates a front view of the image capture computing device receptacle with a mobile computing device secured to the image capture computing device receptacle.

FIG. 5 illustrates a front view of the image capture computing device receptacle 100 with the mobile computing device secured to the image capture computing device receptacle and the image capture computing device receptacle having a bottom handle.

FIG. 6 illustrates a front view of the image capture computing device receptacle with the mobile computing device secured to the image capture computing device receptacle and the image capture computing device receptacle only having the right handle for a handle.

FIG. 7 illustrates a front view of an image capture computing device receptacle that is configured to receive a smartphone.

FIG. 8 illustrates a back view of the image capture computing device receptacle illustrated in FIG. 7.

FIG. 9A illustrates a front perspective view of the flat handle configuration of the image capture computing device receptacle.

FIG. 9B illustrates a front view of the flat handle configuration of the image capture computing device receptacle illustrated in FIG. 9A.

FIG. 9C illustrates a side view of the flat handle configuration of the image capture computing device receptacle illustrated in FIG. 9A.

FIG. 9D illustrates another side view of the flat handle configuration of the image capture computing device receptacle illustrated in FIG. 9A.

FIG. 10A illustrates a front perspective view of an example of the apparatus.

FIG. 10B illustrates a rear perspective view of the example of the apparatus illustrated in FIG. 10A.

FIG. 11A illustrates a front perspective view of the apparatus.

FIG. 11B illustrates a side view of the apparatus illustrated in FIG. 11A.

FIG. 12 illustrates a receptacle receiver that receives the receptacle connection device.

FIG. 13A illustrates the receptacle receiver being positioned above the receptacle connection device so that the receptacle receiver may slide in a downward motion on to the receptacle connection device.

FIG. 13B illustrates the receptacle being attached to the apparatus as a result of the receptacle receiver being slid on to the receptacle connection device.

FIG. 14A illustrates a front perspective view of a handle configuration in which a right handle and a left handle are integrated into the apparatus.

FIG. 14B illustrates a rear perspective view of the handle configuration illustrated in FIG. 14A.

FIG. 15A illustrates a front perspective view of the image capture device and a front perspective view of the receptacle.

FIG. 15B illustrates a rear perspective view of the image capture device and a front perspective view of the receptacle.

FIG. 16A illustrates an example of an image capture computing device that is a smartphone having different dimensions than the image computing device illustrated in FIGS. 14A and 14B.

FIG. 16B illustrates an example of an image capture computing device that is a tablet device having different dimensions than the image computing device illustrated in FIGS. 14A and 14B.

### DETAILED DESCRIPTION

A receptacle for a computing device that performs image capture is provided. The image capture computing device is received by the receptacle. A user then grasps the receptacle and motions the receptacle to a position for image capture. The receptacle has handles that provide for stabilization of the receptacle and the image capture computing device. As a result, users performing image capture have the ability to capture still images and/or video images with stabilization. In contrast with heavy receptacles that do not have handles, the receptacle for the image capture computing device provides a lightweight configuration that provides stabilization for an image capture computing device.

Further, the receptacle is configured to provide optimal accessibility to various ports of the mobile computing device. In contrast with a configuration in which wires have to be bent in a manner that may damage the wires and be cumbersome for a user, the receptacle is configured to maximize accessibility to the mobile computing device and minimize interference from the wires.

In addition, the receptacle may have additional components that allow the user performing image capture to vary image capture conditions. For example, the receptacle may receive a variety of lenses that may be utilized to vary viewing conditions. Further, various lighting and/or audio equipment may be positioned on the receptacle to vary lighting and/or audio conditions. The receptacle may also have a tripod component so that the receptacle may be stabilized with a tripod to minimize motion of the image capture computing device during image capture.

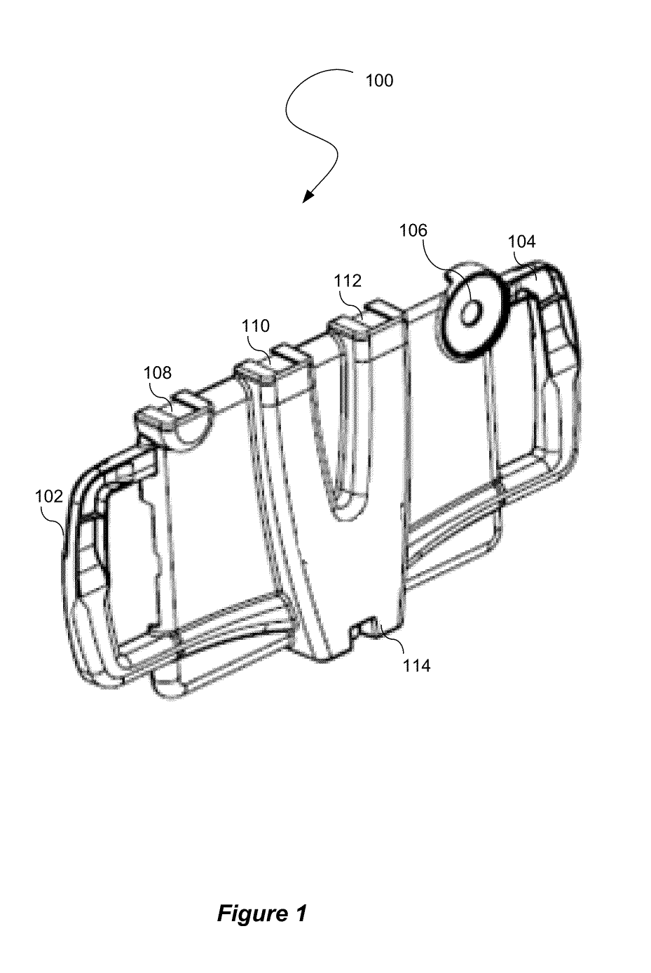

FIG. 1 illustrates a front view of an image capture computing device receptacle 100. In one embodiment, the image capture computing device receptacle 100 includes a plurality of handles, e.g., a right handle 102 and a left handle 104. The front of the image capture computing device receptacle 100 is illustrated from the perspective of what another user views if in front of the image capture computing device 100 when an image is captured by a user such as a photographer. The right handle 102 and the left handle 104 allow the user to perform image capture with minimal wobbling. As a result, the photographer is able to perform image capture with more stabilization and accuracy than without the image capture computing device receptacle 100. Although the right handle 102 and the left handle 104 are illustrated, the handles may be in other locations, e.g., a top handle and a bottom handle. Further, a single handle or more than two handles may be utilized. The right handle 102 and the left handle 104 are provided merely for illustrative purposes.

The image capture computing device receptacle 100 also has an aperture 106. The aperture 106 is configured so that an image capture component, e.g., a lens of a mobile image capture computing device, may be positioned to capture images through the aperture 106. In one embodiment, the aperture 106 is configured to be in substantial proximity to the image capture component. For example, the aperture may be narrow enough to only be positioned over the lens to minimize reflection.

In another embodiment, the image capture computing device receptacle 100 has a plurality of accessory receiving means. As an example, the image capture computing device receptacle 100 has a receiving means 108, a receiving means 110, a receiving means 112, and a receiving means 114. The various receiving means may be utilized to receive accessories such as lighting devices, e.g., lamps, audio devices, e.g., microphones, additional lenses, e.g., wide angle lenses, tripods, and/or the like. For example, the receiving means 114 may receive a tripod mount to provide further stabilization for the image capture computing device receptacle 100 with a tripod. A single or different quantity of receiving means may be utilized from that illustrated in FIG. 1.

In one embodiment, the right handle 102 and the left handle 104 are integrated within the same frame as the image capture computing device receptacle 100. In other words, a single molding may be utilized for the frame and the handles. In an alternative embodiment, the right handle 102 and the left handle are detachable from the frame.

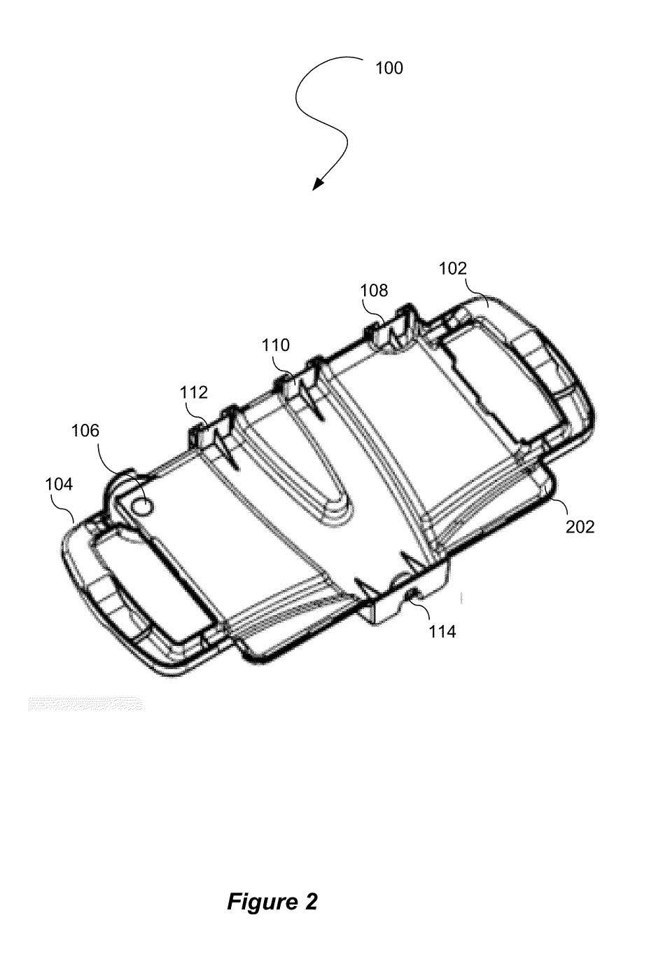

FIG. 2 illustrates a back view of the image capture computing device receptacle 100. The back view is from the perspective of the photographer that is placing the mobile computing device in the image capture computing device receptacle 100. In one embodiment, the image capture computing device receptacle 100 has a receiving means for receiving the image capture computing device receptacle 100. An example of the receiving means is the lip 202. The lip 202 may be positioned throughout all of the frame or at least a portion of the frame. A photographer may then snap the mobile computing device within the lip to secure the mobile computing device in the image capture computing device receptacle 100. As a result, the photographer may easily snap the mobile computing device into position. The lip is only an example of the receiving means. The receiving means may also be a fastening means such as a screw, bolt, nail, clip, and/or the like.

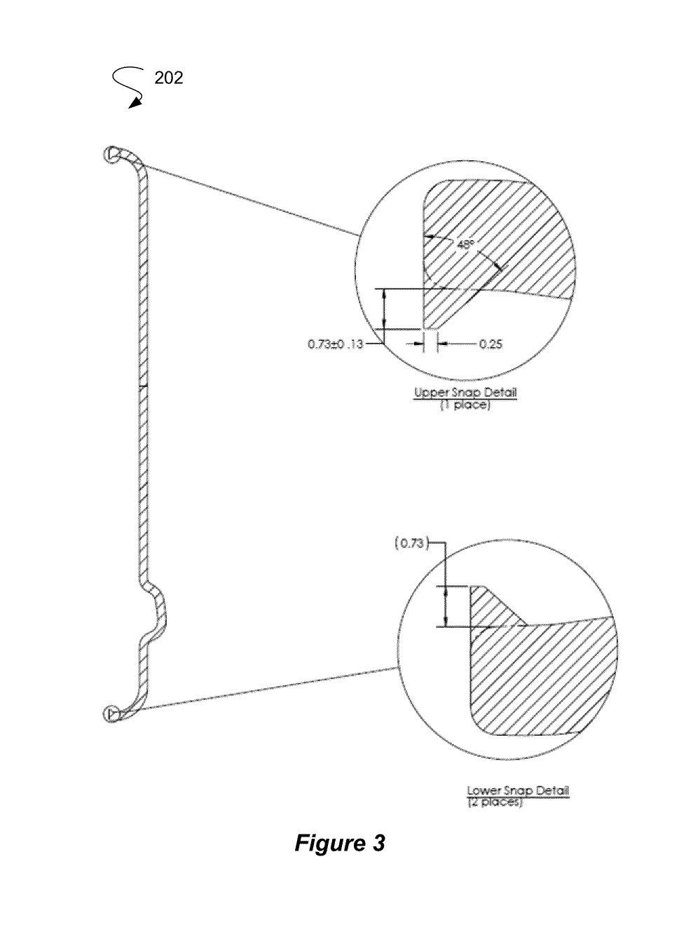

FIG. 3 illustrates a side view of the receiving means 202. The receiving means 202 is illustrated as a lip only for illustrative purposes as various other receiving means may be utilized.

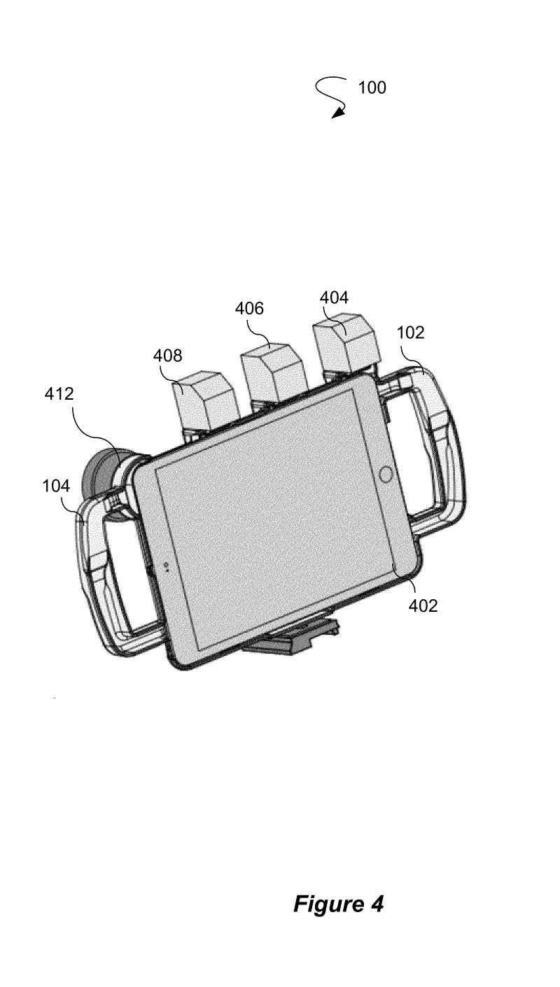

FIG. 4 illustrates a front view of the image capture computing device receptacle 100 with a mobile computing device 402 secured to the image capture computing device receptacle 100. The mobile computing device 402 may be a tablet device, smartphone, or any other mobile device. Further, the mobile computing device 402 may have an image capture component, e.g., a built in camera, for still or motion image capture. Various accessories 404, 406, and 408 may be connected to the receiving means 108, 110, and 112. The receiving means 108, 110, and 112 may be a lip, screw, bolt, nail, clip, and/or the like. Further, a lens accessory 412 is positioned over the aperture 106.

Although a frame single frame is illustrated in FIG. 4, multiple frames may alternatively be utilized to secure the mobile computing device 402. In other words, the image capture computing device receptacle 100 may comprise multiple parts such as a front portion and a back portion to secure the mobile computing device 402 to the image capture computing device receptacle 100. Accordingly, the image capture computing device receptacle 100 is not limited to a single frame as multiple frames may alternatively be utilized.

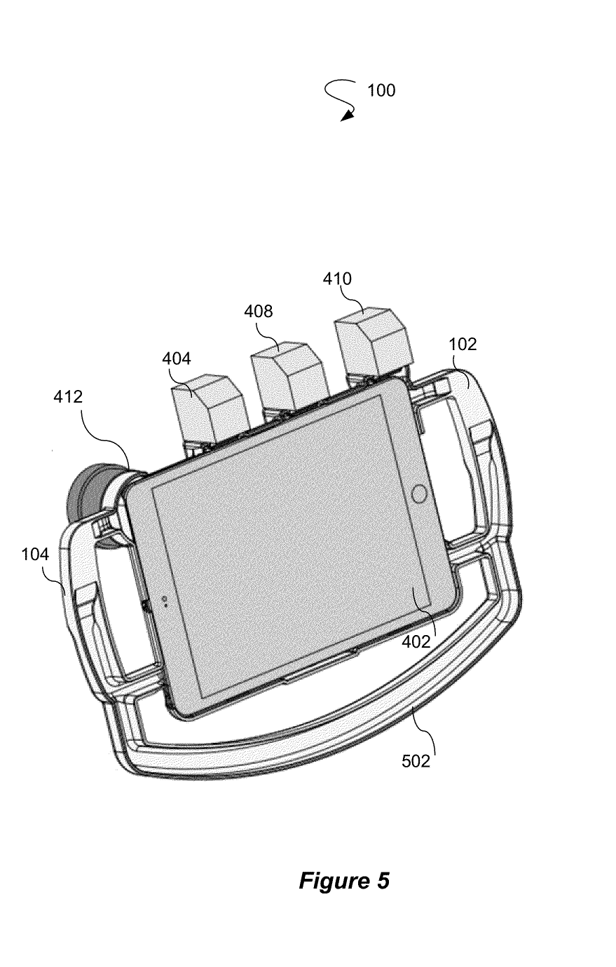

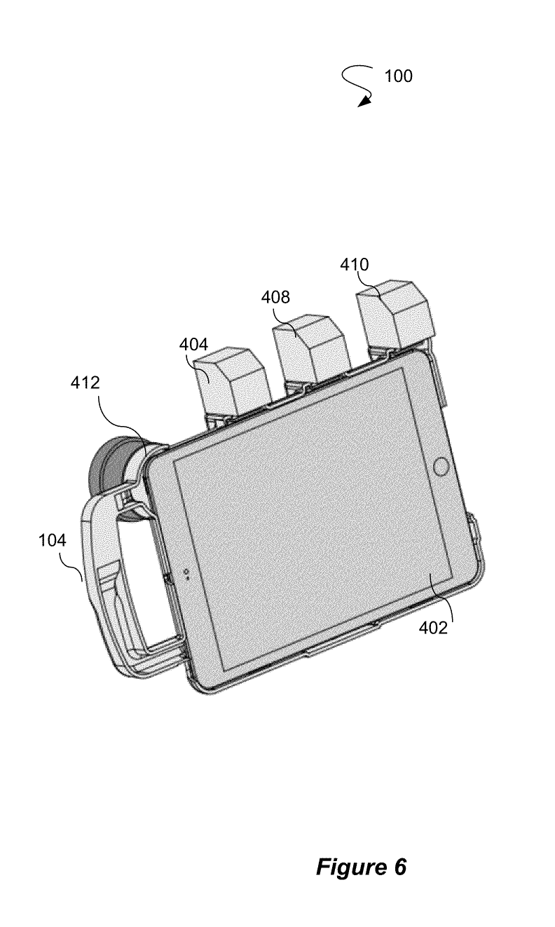

Although FIGS. 1-4 illustrated two handles, a single handle or more than two handles may be utilized. FIG. 5 illustrates a front view of the image capture computing device receptacle 100 with the mobile computing device 402 secured to the image capture computing device receptacle 100 and the image capture computing device receptacle 100 having a bottom handle 502. Alternatively, the right handle 102, the left handle 104, and the bottom handle 502 may be considered a single handle. Further, FIG. 6 illustrates a front view of the image capture computing device receptacle 100 with the mobile computing device 402 secured to the image capture computing device receptacle 100 and the image capture computing device receptacle 100 only having the left handle 104 for a handle.

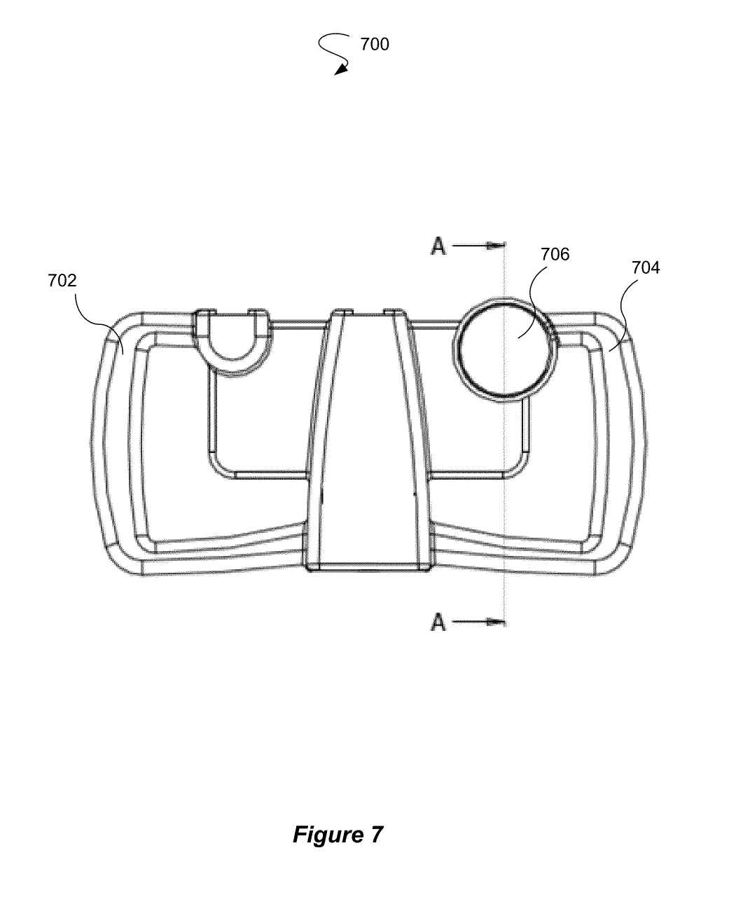

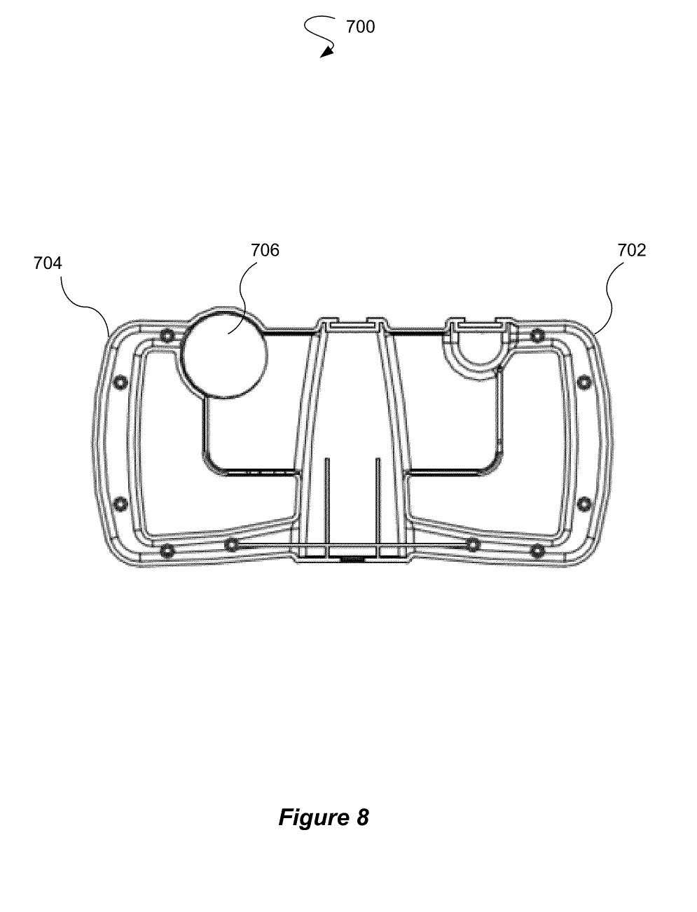

Although FIGS. 4-6 illustrate the mobile computing device 402 as a tablet device, a smartphone may alternatively be utilized. Accordingly, FIG. 7 illustrates a front view of an image capture computing device receptacle 700 that is configured to receive a smartphone. The image capture computing device receptacle 700 has a right handle 702 and a left handle 704. The image capture computing device receptacle 700 also has an aperture 706. FIG. 8 illustrates a back view of the image capture computing device receptacle 700 illustrated in FIG. 7.

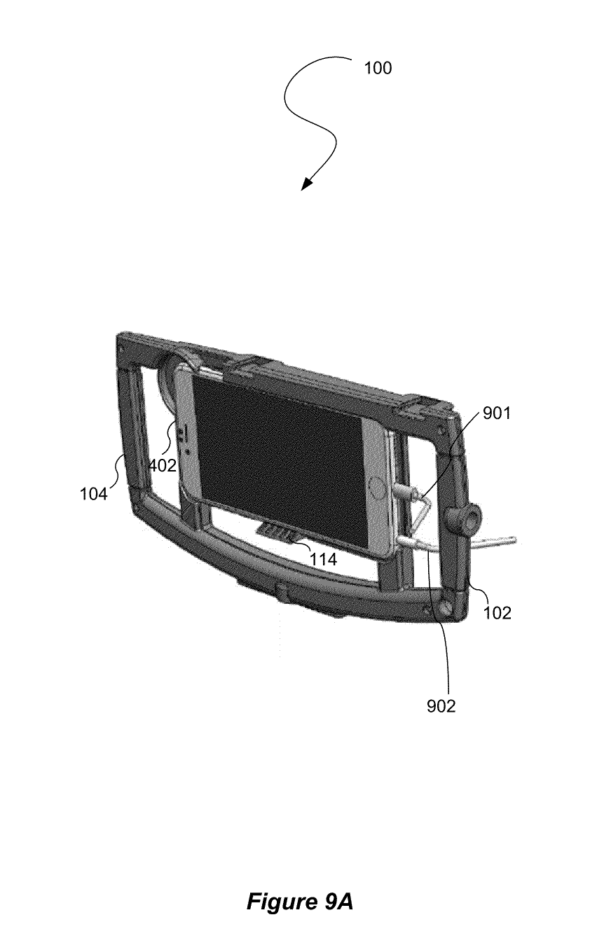

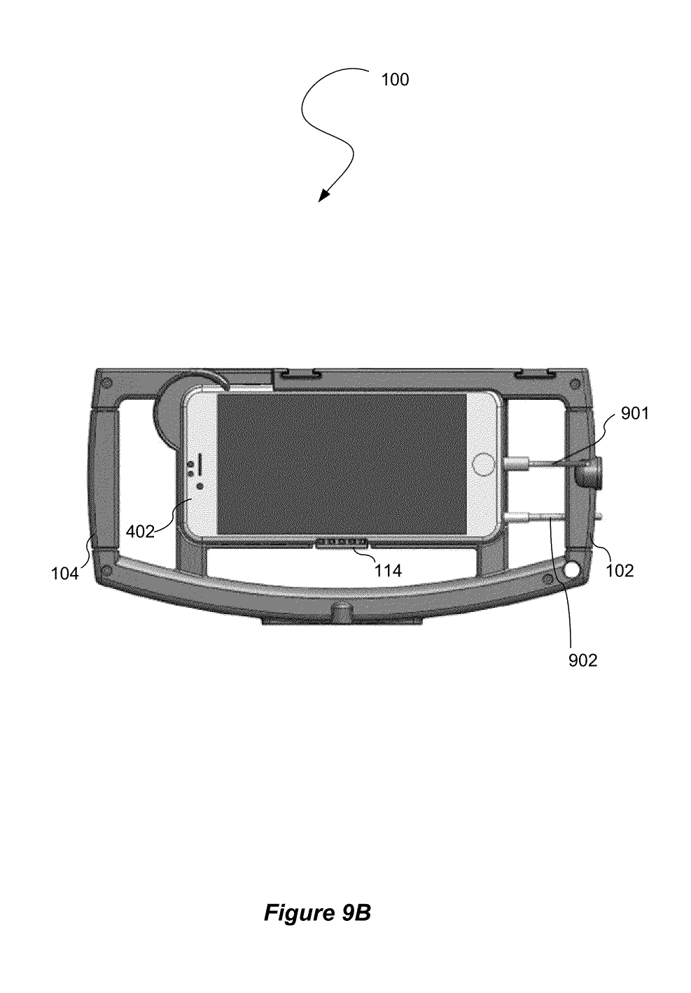

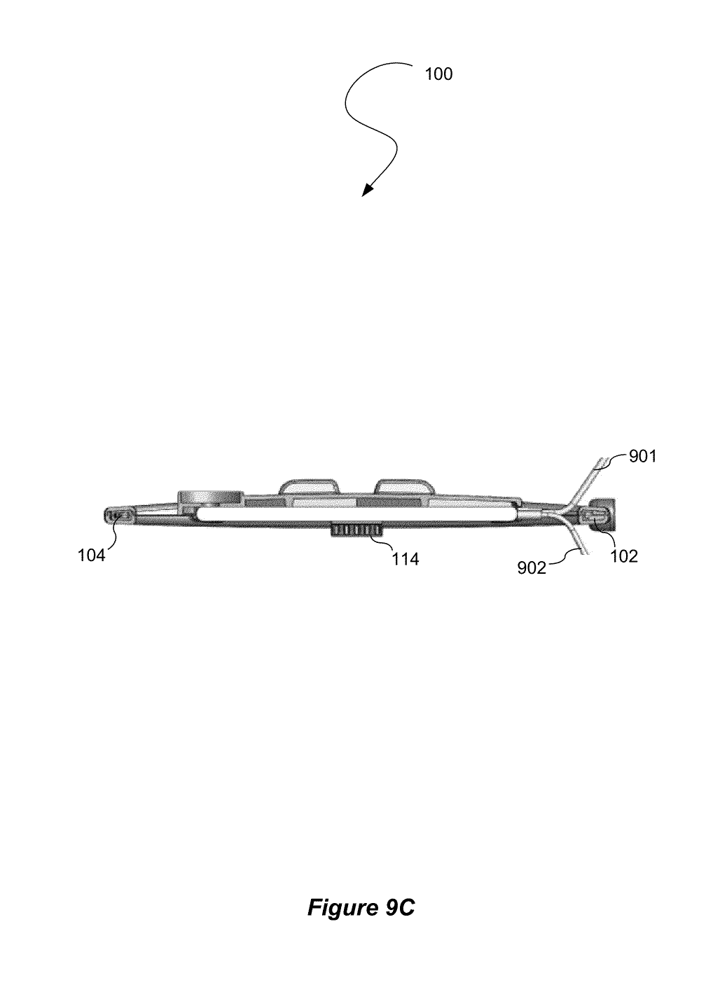

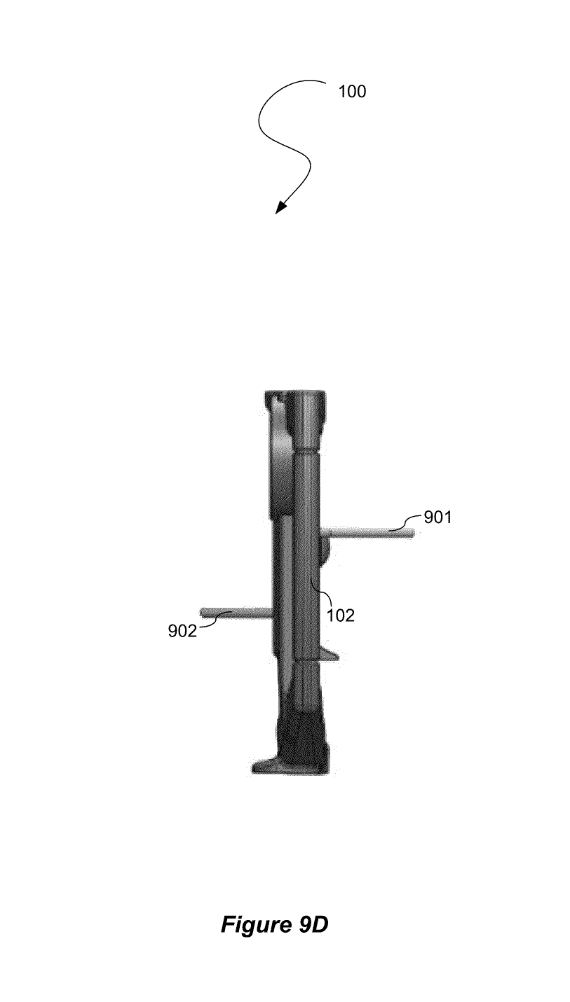

FIGS. 9A-9D illustrate various views of a flat handle configuration of the image capture computing device receptacle 100 illustrated in FIG. 1. The flat handle configuration has handles that are in vertical alignment with the vertical plane that goes through the image capture computing device receptacle 100. As a result various wires that are plugged into the mobile computing device 402 of FIG. 4 have to be bent, twisted, etc. to have accessibility to receiving ports of the mobile computing device 402 of FIG. 4. Such wires may be utilized to connect the image capture computing device 100 to various accessories, other devices, etc. The ports may be based on various technologies such as USB, Ethernet, etc.

FIG. 9A illustrates a front perspective view of the flat handle configuration of the image capture computing device receptacle 100. The right handle 102 and the left handle 104 are in vertical alignment with the image capture computing device receptacle 100. As a result, a lighting cable 901 and a headphone cable 902 do not have direct accessibility to receiving ports of the mobile computing device 402. Therefore, the cables 901 and 902 have to be significantly bent, e.g., at approximate ninety degree angles, to obtain access to the receiving ports of the mobile computing device 402 of FIG. 4.

Such awkward bending may lead to significant damage or wear and tear of the cables 901 and 902. Further, the cables 901 and 902 may easily become unplugged from the receiving ports of the mobile computing device 402 of FIG. 4 as such bending does not allow for secure plugging of the cables 901 and 902. Such unplugging may lead to significant disruptions during filming, image capture, etc.

Further, the bending of the cables 901 and 902 interferes with a user's ability to comfortably grip the handles 102 and 104. For example, the bends of the cables 901 and 902 may occupy significant amounts of gripping space between the handles 102 and 104 and the portion of the image capture computing device receptacle 100 that encapsulates the mobile computing device 402. As a result, the bends of the cables 901 and 902 may block certain portions of the handles 102 and 104 from being gripped by the user.

FIG. 9B illustrates a front view of the flat handle configuration of the image capture computing device receptacle 100 illustrated in FIG. 9A. Further, FIG. 9C illustrates a side view of the flat handle configuration of the image capture computing device receptacle 100 illustrated in FIG. 9A. The cables 901 and 902 are illustrated as being significantly bent at almost ninety degree angles. In addition, FIG. 9D illustrates another side view of the flat handle configuration of the image capture computing device receptacle 100 illustrated in FIG. 9A.

The lighting cable 901 and the headphone cable 902 are only provided as examples of cables that may be utilized with the receiving ports of the mobile computing device 402. Other types of cables may also be utilized. Further, devices other than cables that may be received by the mobile computing device 402, e.g., USB devices, etc., may also be received by the receiving ports of the mobile computing device 402.

In yet another implementation, an apparatus is able to connect to a receptacle for the mobile computing device 402. The apparatus allows for connection of various sized receptacles that each fit a particular mobile computing device 402. In other words, the same apparatus may be utilized to connect to various receptacles of different sizes so that the same apparatus may be utilized to perform image capture for different sized mobile computing devices 402.

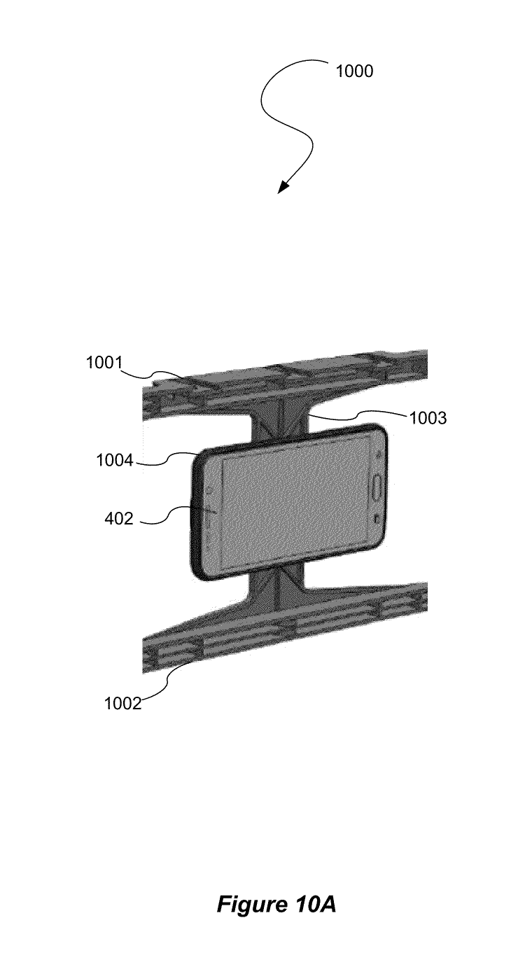

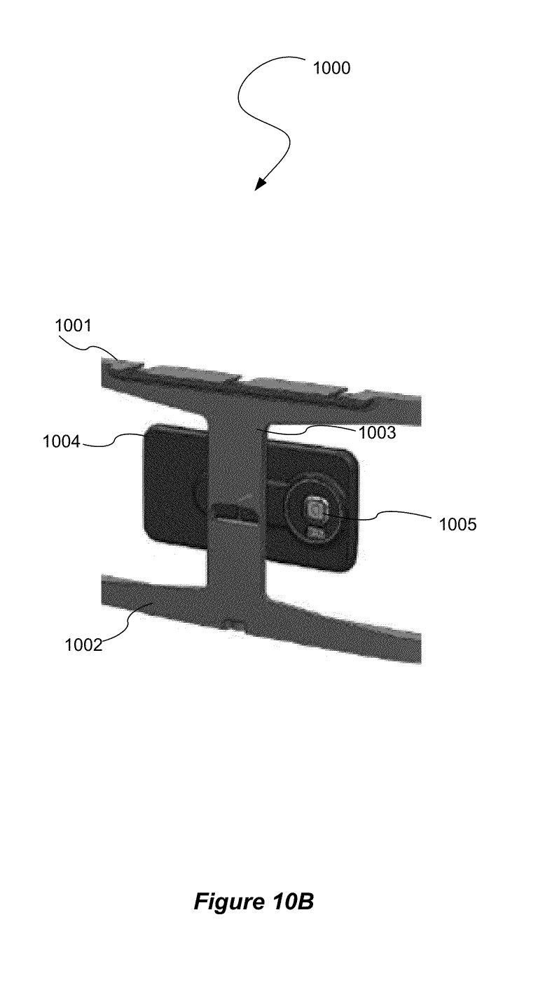

FIGS. 10A and 10B illustrate various views of an apparatus 1000 that may receive different sized receptacles for mobile computing devices 402. FIG. 10A illustrates a front perspective view of an example of the apparatus 1000. The apparatus 1000 receives a first member 1001 and a second member 1002 that are parallel to each other. Further, the apparatus 1000 has a third member 1003 that couples the first member and the second member. For example, the third member 1003 may be positioned in between and perpendicular to the first member 1001 and the second member 1002.

Further, a receptacle 1004 is connected to the third member 1003. The receptacle 1004 is configured to receive the mobile computing device 402 without an intervening member between an external perimeter of the mobile computing device 402 and an external perimeter of the receptacle 1004. In other words, the receptacle 1004 conforms to the shape of the mobile computing device 402. As an example, the receptacle 1004 may be configured so that no space is present between the external perimeter of the mobile computing device 402 and the external perimeter of the receptacle 1004.

The receptacle 1004 may be detached from the apparatus 1000. As a result, different sized receptacles 1004 that accommodate different sized mobile computing devices 402 may be detached and connected to the same apparatus 1000. For example, a user may attach a first receptacle 1004 to accommodate a particular smartphone and then detach that first receptacle 1004 so that a second receptacle 1004 may be attached to accommodate a different sized smartphone. Further, different types of devices with different sizes may be accommodated via the apparatus 1000. For instance, a user may attach a first receptacle 1004 to accommodate a particular smartphone and then detach that first receptacle 1004 so that a second receptacle 1004 may be attached to accommodate a tablet device.

FIG. 10B illustrates a rear perspective view of the example of the apparatus 1000 illustrated in FIG. 10A. The receptacle 1004 has an aperture 1005 next to which a lens of the mobile computing device 402 is positioned. The aperture 1005 is positioned on a side of the third member 1003 so that the aperture 1005 has an unobstructed view for image capture.

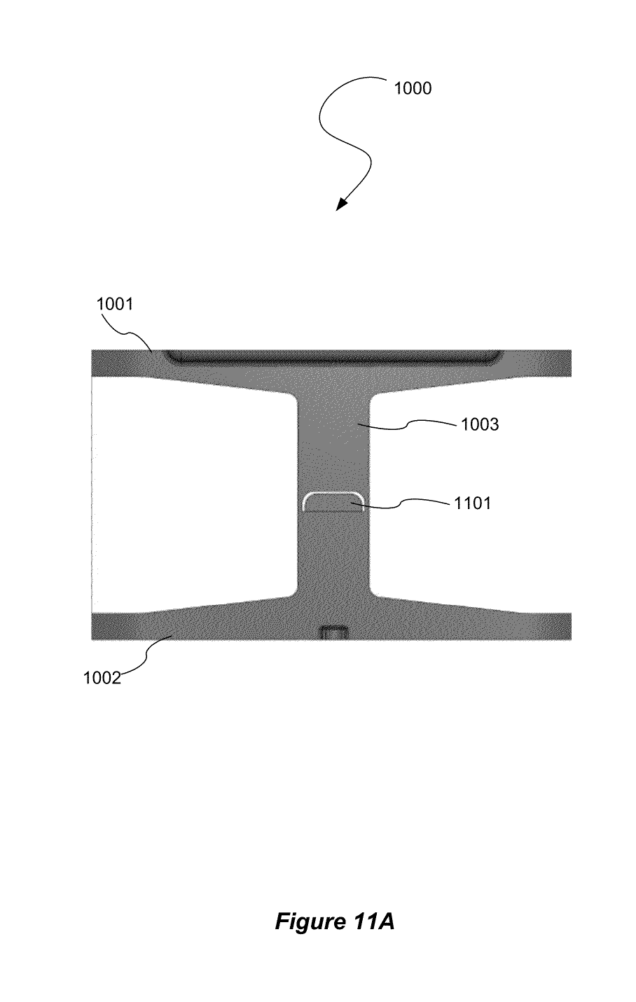

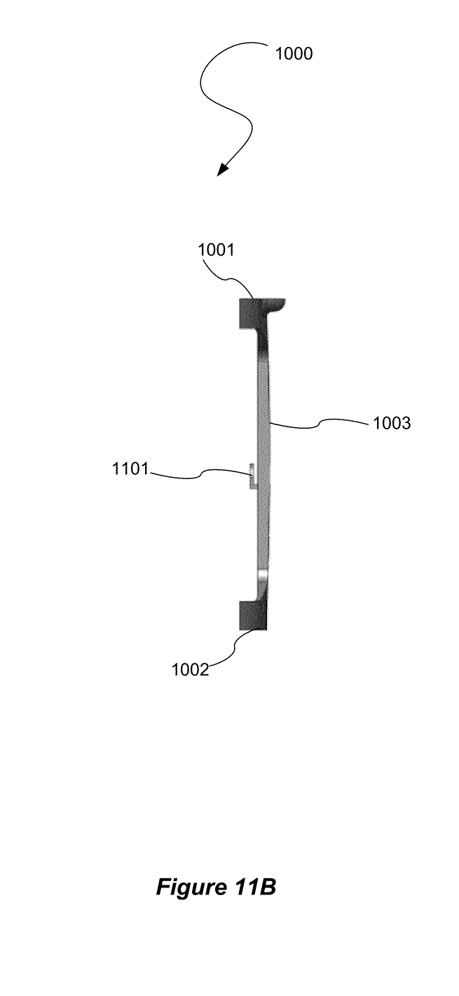

FIGS. 11A and 11B illustrate various view of the apparatus 1000 illustrated in FIG. 10 without the receptacle 1004 being connected to the third member 1003. FIG. 11A illustrates a front perspective view of the apparatus 1000. The apparatus 1000 has a receptacle connection device 1101 that connects the receptacle 1004 to the apparatus. For instance, the receptacle connection device 1101 may be a clip. FIG. 11B illustrates a side view of the apparatus 1000 illustrated in FIG. 11A.

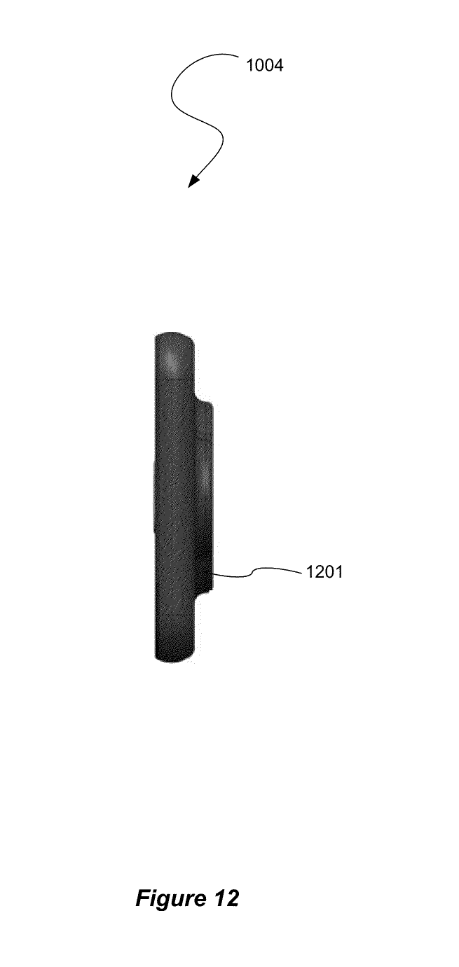

FIG. 12 illustrates a receptacle receiver 1201 that receives the receptacle connection device 1101. In other words, the receptacle receiver 1201 is positioned to connect the receptacle 1004 to the receptacle connection device 1101 of the apparatus 1000.

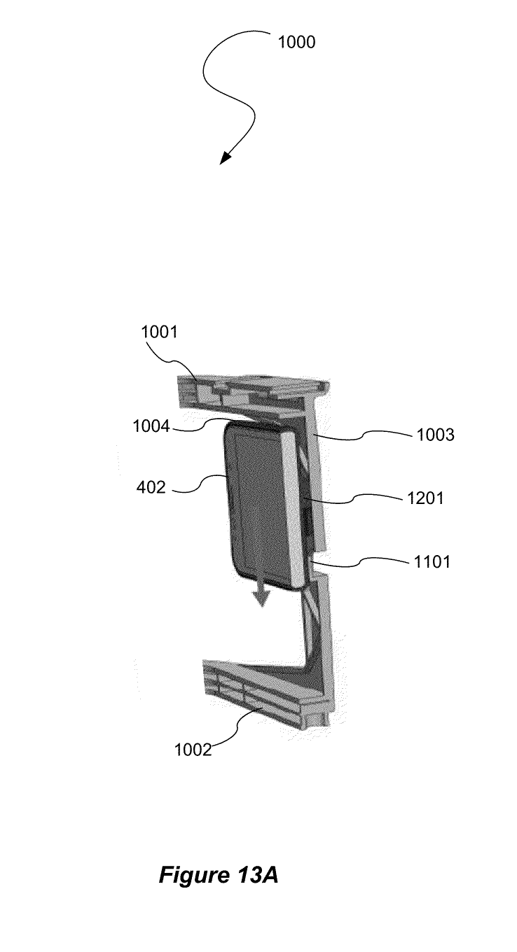

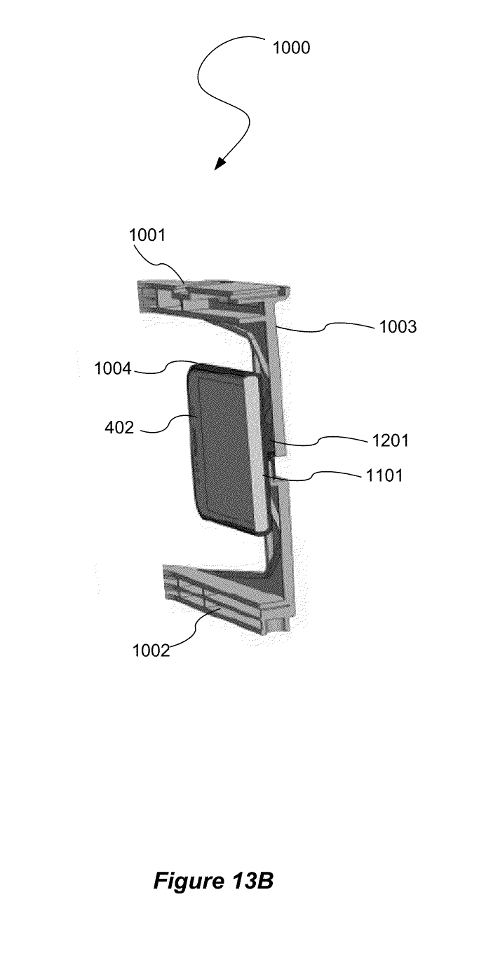

FIGS. 13A and 13B illustrates a partial perspective view of the receptacle 1004 being connected to the apparatus 1000. FIG. 13A illustrates the receptacle receiver 1201 being positioned above the receptacle connection device 1101 so that the receptacle receiver 1201 may slide in a downward motion on to the receptacle connection device 1101. FIG. 13B illustrates the receptacle 1004 being attached to the apparatus 1000 as a result of the receptacle receiver being slid on to the receptacle connection device 1101.

In an alternative implementation, the receptacle connection device 1101 may be positioned on the receptacle 1004, and the receptacle receiver 1201 may be positioned on the third member 1003 of the apparatus. In another alternative implementation, the receptacle connection device 1101 or the receptacle receiver 1201 may be positioned on the first member 1001 or the second member 1002.

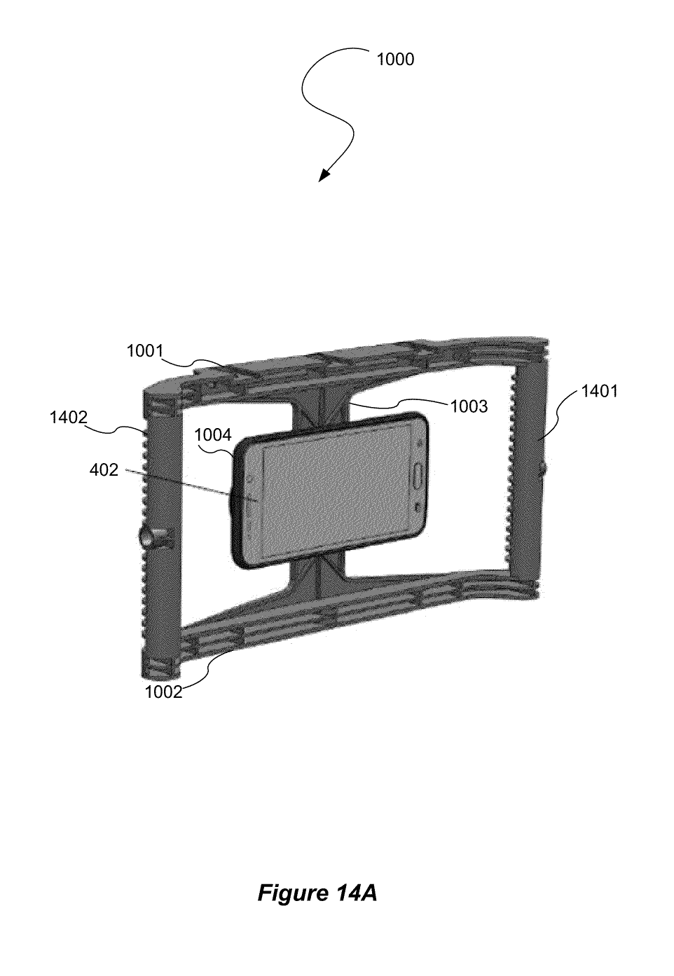

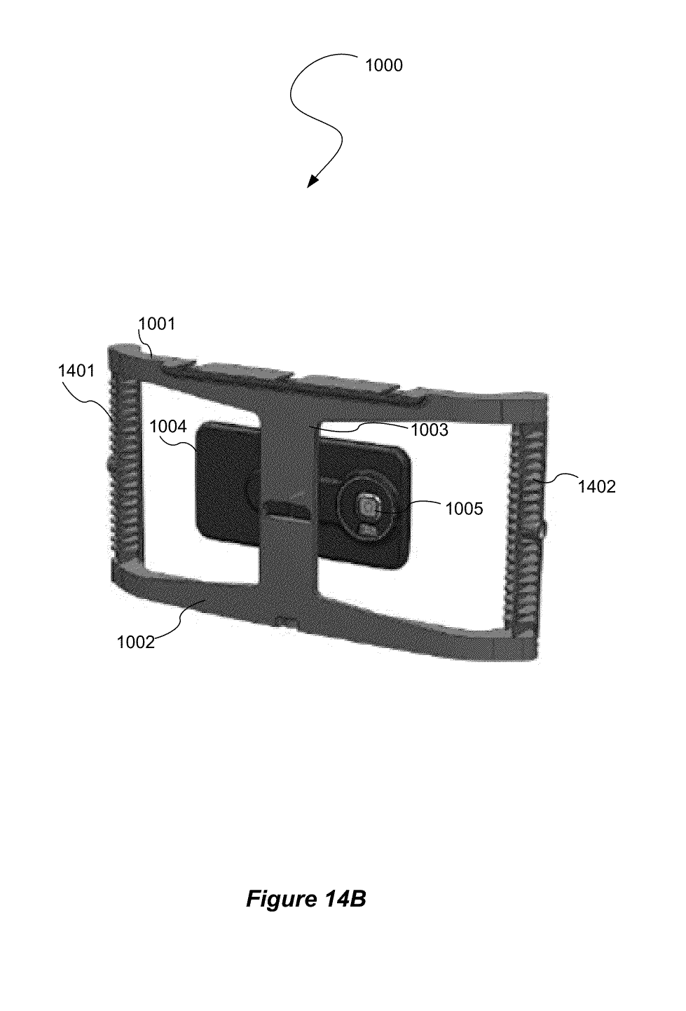

In yet another alternative implementation, handles may be either attached to or integrated into the apparatus 1000 illustrated in FIGS. 10A and 10B. FIGS. 14A and 14B illustrate various views of a handle configuration that may be utilized with the apparatus 1000. FIG. 14A illustrates a front perspective view of a handle configuration in which a right handle 1401 and a left handle 1402 are integrated into the apparatus 1000. The handles 1401 and 1402 may extend outward in the same perimeter of the apparatus 1000. Alternatively, the handles 1401 and 1402 may be directed toward a user gripping the handles 1401 and 1402. For example, the handles 1401 and 1402 may be curved toward the user. As yet another alternative, the handles 1401 and 1402 may be directed away from a user gripping the handles 1401 and 1402. For example, the handles 1401 and 1402 may be curved away from the user. FIG. 14B illustrates a rear perspective view of the handle configuration illustrated in FIG. 14A.

Various quantities and types of handles may be utilized with the apparatus 1000. For example, less than two or more than two handles may be utilized. As another example, ribbed handles may be utilized.

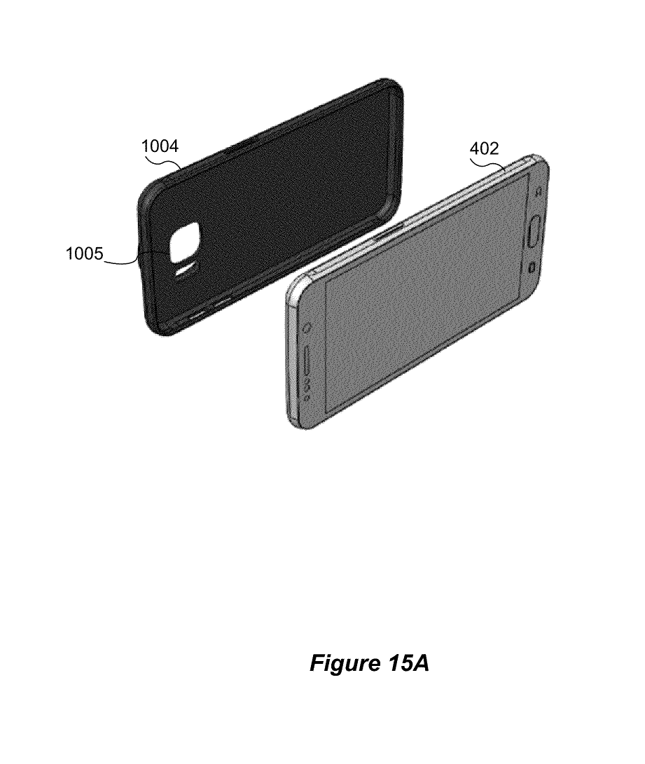

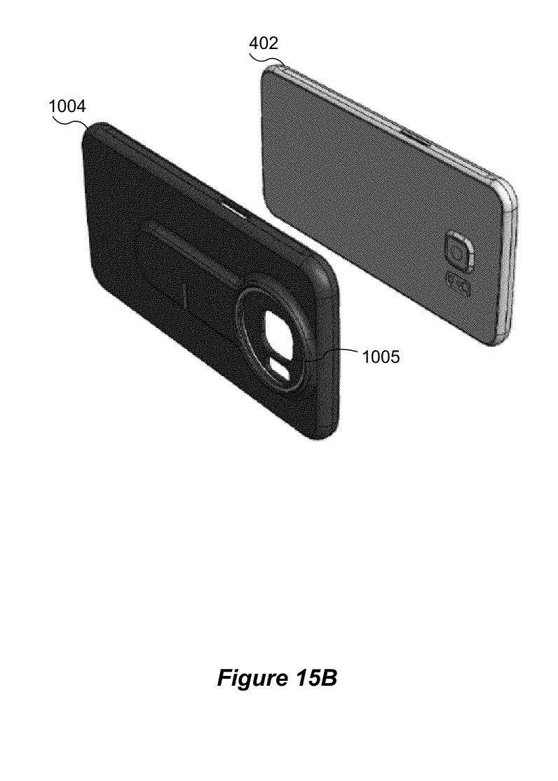

Further, FIGS. 15A and 15B illustrate various views of the image capture device 402 and the receptacle 1004. FIG. 15A illustrates a front perspective view of the image capture device 402 and a front perspective view of the receptacle 1004. Further, FIG. 15B illustrates a rear perspective view of the image capture device 402 and a front perspective view of the receptacle 1004.

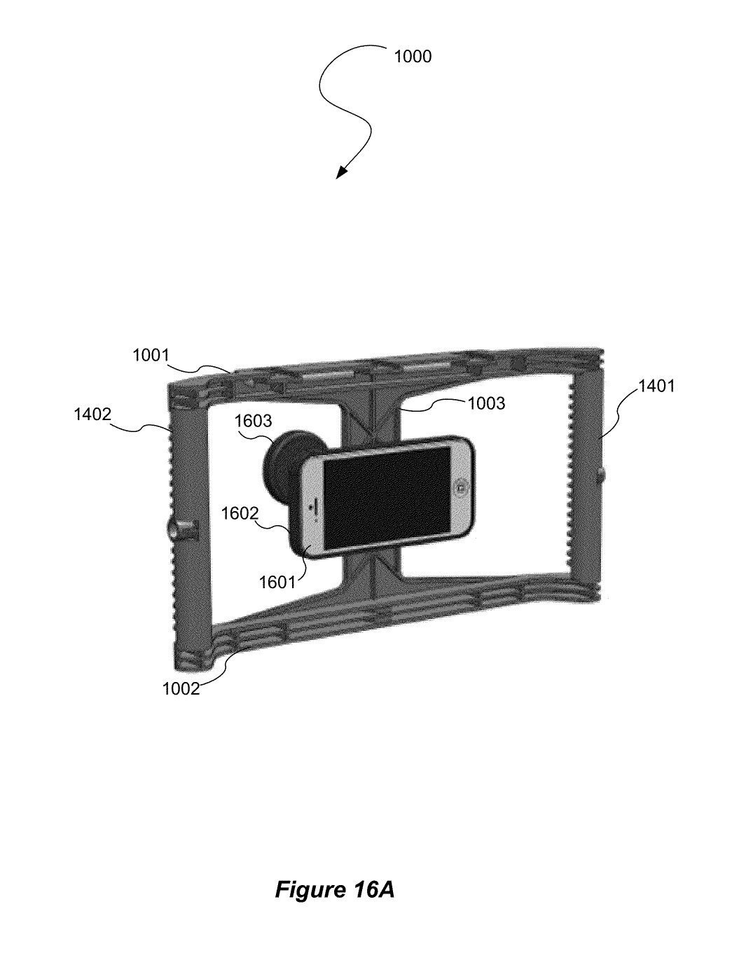

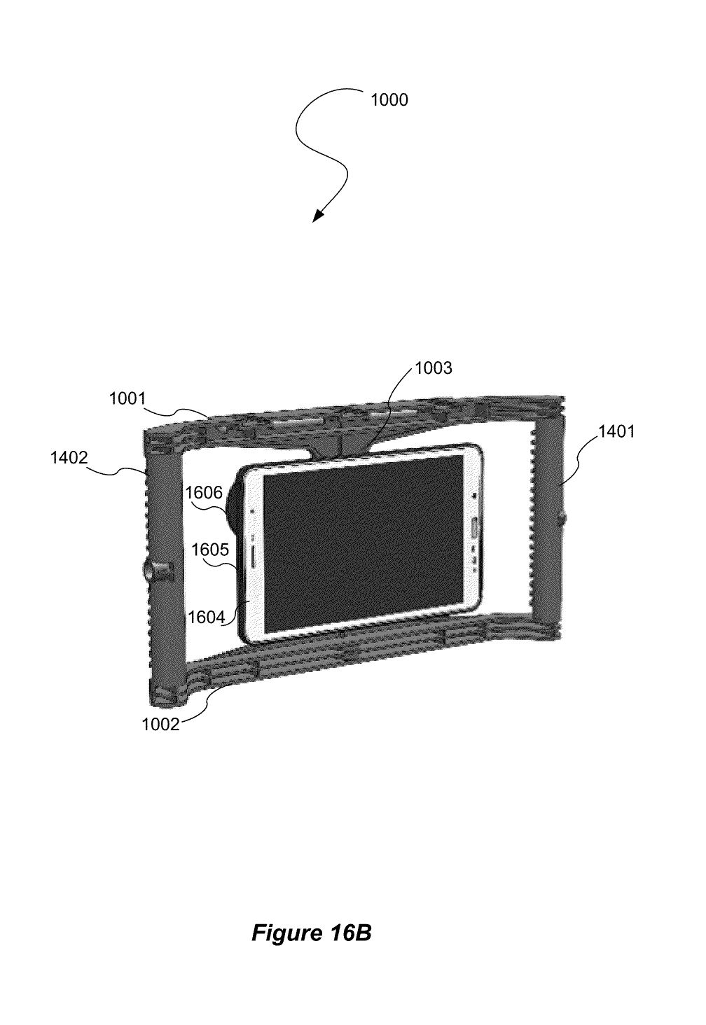

In addition, FIGS. 16A and 16B illustrate different sized image capture computing devices 1601 and 1604 that may be utilized with the apparatus 1000 illustrated in FIGS. 14A and 14B or any of the other described configurations instead of the mobile computing device 402. FIG. 16A illustrates an example of an image capture computing device 1601 that is a smartphone having different dimensions than the image computing device 402 illustrated in FIGS. 14A and 14B. As a result, a receptacle 1602 also has different dimensions than the receptacle 1004 illustrated in FIGS. 14A and 14B to conform to the shape of the different sized image capture computing device 1601. Further, a lens accessory 1603 may be attached to or integrated into the receptacle 1602 for the image capture device 1601 to utilize for image capture.

FIG. 16B illustrates an example of an image capture computing device 1604 that is a tablet device having different dimensions than the image computing device 402 illustrated in FIGS. 14A and 14B. As a result, a receptacle 1605 also has different dimensions than the receptacle 1004 illustrated in FIGS. 14A and 14B to conform to the shape of the different sized image capture computing device 1604. Further, a lens accessory 1606 may be attached to or integrated into the receptacle 1605 for the image capture device 1601 to utilize for image capture.

A variety of types of materials may be utilized for the image capture computing device receptacles. For example, plastic, carbonite, metal, or the like may be utilized.

It is understood that the apparatuses described herein may also be applied in other types of apparatuses. Those skilled in the art will appreciate that the various adaptations and modifications of the embodiments of the apparatuses described herein may be configured without departing from the scope and spirit of the apparatuses. Therefore, it is to be understood that, within the scope of the appended claims, the present apparatuses may be practiced other than as specifically described herein.

We claim:

1. An apparatus comprising:
a first member;
a second member;
a third member that couples the first member and the second member such that the second member is parallel to the first member, the third member is perpendicular to the first member and the second member, and the third member is in between the first member and the second member; and
a receptacle connection device positioned on the third member that connects a receptacle to the apparatus, the receptacle configured to receive an image capture computing device without an intervening member between an external perimeter of the image capture computing device and an external perimeter of the receptacle, the receptacle configured to have an aperture positioned on a side of the third member between the first member and the second member.

2. The apparatus of claim 1, wherein a lens of the image capture computing device is positioned in proximity to the aperture.

3. The apparatus of claim 1, wherein the receptacle connection device is a clip on to which a connector of the receptacle is clipped.

4. The apparatus of claim 1, wherein the receptacle connection device detachably connects the receptacle to the apparatus.

5. The apparatus of claim 1, wherein the receptacle connection device is configured to disconnect from the receptacle and connect to an additional receptacle, the additional receptacle having distinct dimensions from the first receptacle.

6. The apparatus of claim 1, wherein a vertical positioning of the third member allows for a horizontal positioning of the receptacle connected to the third member via the receptacle connection device.

7. The apparatus of claim 1, wherein a vertical positioning of the third member allows for a vertical positioning of the receptacle connected to the third member via the receptacle connection device.

8. The apparatus of claim 1, wherein the image capture computing device is selected from the group consisting of a smartphone and a tablet device.

9. The apparatus of claim 1, wherein the first member and the second member extend outward beyond the perimeter of the third member.

10. The apparatus of claim 1, wherein a perimeter of the receptacle is less than a perimeter of the apparatus.

11. An apparatus comprising:
a first member;
a second member;
a third member that couples the first member and the second member such that the second member is parallel to the first member, the third member is perpendicular to the first member and the second member, and the third member is in between the first member and the second member;
a receptacle connection device positioned on the third member that is capable of connecting a first receptacle or a second receptacle to the apparatus, the first receptacle configured to receive a first image capture computing device without an intervening member between an external perimeter of the first image capture computing device and an external perimeter of the first receptacle, the first receptacle configured to have an aperture positioned on a side of the third member between the first member and the second member, the second receptacle configured to receive a second image capture computing device without an intervening member between an external perimeter of the second image capture computing device and an external perimeter of the second receptacle, the second receptacle configured to have an aperture positioned on a side of the third member between the first member and the second member, the first receptacle having a first set of dimensions, the second receptacle having a second set of dimensions, the first set of dimensions being distinct from the second set of dimensions.

12. The apparatus of claim 11, wherein a first lens of the first image capture computing device is positioned in proximity to the aperture.

13. The apparatus of claim 11, wherein a second lens of the second image capture computing device is positioned in proximity to the aperture.

14. The apparatus of claim 11, wherein the receptacle connection device is a clip on to which a connector of the receptacle is clipped.

15. The apparatus of claim 11, wherein the receptacle connection device detachably connects the first receptacle to the apparatus.

16. The apparatus of claim 11, wherein the receptacle connection device detachably connects the second receptacle to the apparatus.

17. The apparatus of claim 11, wherein a vertical positioning of the third member allows for a horizontal positioning of the receptacle connected to the third member via the receptacle connection device.

18. The apparatus of claim 11, wherein the image capture computing device is selected from the group consisting of a smartphone and a tablet device.

19. The apparatus of claim 11, wherein the first member and the second member extend outward beyond the perimeter of the third member.

20. The apparatus of claim 1, wherein a first perimeter of the first receptacle and a second perimeter of the second receptacle are each less than a perimeter of the apparatus.
